(19) United States
(12) Patent Application Publication
(10) Pub. No.: US 2026/0264442 A1
(43) Pub. Date: Sep. 10, 2026

(54) PHOSPHOR-BASED PEN FOR AUTHENTICATION AND SECURITY

(71) Applicant: INTELLIGENT MATERIAL SOLUTIONS, INC., Princeton, NJ (US)

(72) Inventors: Sean Morey, Princeton, NJ (US); Joshua T. Stecher, Trenton, NJ (US); Howard Y. Bell, Princeton, NJ (US); John Wolfe, Princeton, NJ (US); Viva Bell, Princeton, NJ (US); Joshua E. Collins, Wallingford, NJ (US)

(73) Assignee: INTELLIGENT MATERIAL SOLUTIONS, INC., Princeton, NJ (US)

(21) Appl. No.: 19/552,502

(22) Filed: Feb. 27, 2026

Related U.S. Application Data
(60) Provisional application No. 63/764,276, filed on Feb. 27, 2025.

(51) Int. Cl. B42D 25/382; B42D 25/21; B42D 25/305; B42D 25/328; B42D 25/373; B42D 25/387

(52) U.S. Cl. CPC B42D 25/382; B42D 25/21; B42D 25/305; B42D 25/328; B42D 25/373; B42D 25/387

(57) ABSTRACT

A pen includes a pen body, a pen tip at a first end of the pen body, and one or more ink compartments within the pen body. Each ink compartment is operably coupled to the pen tip so as to dispense ink within the ink compartment substantially simultaneously. The ink contains phosphors that convert UV and IR light into visible emissions.

### CROSS-REFERENCE TO RELATED APPLICATIONS

This application claims priority to U.S. Application No. 63/764,276, titled “PHOSPHOR-BASED PEN FOR AUTHENTICATION AND SECURITY”, filed Feb. 27, 2025, which is hereby incorporated by reference in its entirety.

### FIELD OF INVENTION

The present disclosure relates to authentication and security devices, and more particularly to a pen designed to house and dispense phosphors that convert ultraviolet (UV) and infrared (IR) light into visible colors for covert and overt authentication of merchandise, documents, and branding materials.

### BACKGROUND

Counterfeiting of official sports merchandise and branded corporate products represents a substantial challenge that leads to financial losses and undermines brand integrity. The authentication of memorabilia, game-used items, autographed merchandise, and high-value brand identity items has become increasingly difficult as counterfeiters develop more sophisticated replication techniques. Traditional authentication methods, such as holograms and QR codes, have proven susceptible to replication, rendering them insufficient for robust verification in many applications.

Authentication systems for documents, signatures, and branded materials have evolved to incorporate various security features. These features may include visible markers that can be detected by the human eye, as well as covert markers that require specialized equipment for detection. The use of luminescent materials, including phosphors that respond to ultraviolet or infrared excitation, has been explored as a means of providing authentication capabilities. Such materials can be incorporated into inks and other marking compositions to enable verification of authenticity.

Phosphors are materials that absorb light at one wavelength and emit light at a different wavelength. Upconverting phosphors absorb lower-energy light, such as infrared radiation, and emit higher-energy visible light. Downconverting phosphors absorb higher-energy light, such as ultraviolet radiation, and emit lower-energy visible light. The spectral characteristics, as well as the temporal properties including rise time and decay time of the luminescent emissions, can vary depending on the specific phosphor composition.

Writing instruments that dispense ink containing security features have been developed for various applications. Such instruments may be used to create marks, signatures, or other indicia on substrates including merchandise, documents, and packaging materials. The ability to verify the authenticity of such marks after they have been applied to a substrate is desirable in many commercial and forensic contexts.

Systems for detecting and analyzing luminescent emissions from security markers have been developed using various light sources and detection equipment. Mobile devices, including smartphones, have been adapted to serve as platforms for authentication by incorporating appropriate illumination sources and cameras capable of capturing optical responses from security markers.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a pen may be provided. The pen may include a pen body. The pen may include a pen tip at a first end of the pen body. The pen may include one or more ink compartments with the pen body. Each ink compartment may be operably coupled to the pen tip so as to dispense ink within the ink compartment substantially simultaneously. The ink may contain phosphors that convert UV and IR light into distinct visible emissions.

According to other aspects of the present disclosure, the pen may include one or more of the following features. The one or more ink compartments may include a first ink compartment containing a first IR phosphor that may emit a first color under IR excitation and a first UV phosphor that may emit a second color under UV excitation. At least one ink may include a visually distinguishing element, the visually distinguishing element consisting of a reflective element, a holographic element, and/or a fluorescent element. The visually distinguishing element may be selected so as to generate a unique identifying pattern in ink from the pen that has been deposited onto a surface, that may be detected by a sensor after being deposited. At least one ink may include at least one upconverting phosphor. At least one ink may contain a phosphor whose spectral, rise time, and decay may be capable of encoding an identifier specific to that phosphor. The identifier may be a player jersey number or a unique identifier. At least one ink may include a forensic nanocrystal marker as an additional security layer. At least one ink may include black infrared (IR) transparent ink without carbon.

According to another aspect of the present disclosure, a system may be provided. The system may include a pen having a pen body, a pen tip at a first end of the pen body, and one or more ink compartments with the pen body, each ink compartment operably coupled to the pen tip so as to dispense ink within the ink compartment substantially simultaneously, the ink containing phosphors that convert UV and IR light into distinct visible emissions. The system may include an infrared (IR) vertical cavity surface emitting laser (VCSEL) scanner integrated into a smartphone or compact reader. The IR VCSEL scanner may be configured to emit at least one wavelength of light capable of being absorbed by the phosphors in at least one ink.

According to other aspects of the present disclosure, the system may include one or more of the following features. The system may include a clock and a GPS receiver operably coupled to the smartphone or compact reader to provide geo-tracking and date-stamping mechanisms to provide real-time authentication records.

According to another aspect of the present disclosure, a method for authenticating a document, product, or signature may be provided. The method may include writing with a phosphor-based pen whose ink may emit distinct visible emissions under UV and IR excitation. The method may include capturing the emitted color response after exposing the ink to ultraviolet (UV) light and infrared (IR) light. The method may include analyzing the luminescence properties, including spectral, rise time, and decay signatures, to determine encoded data. The method may include detecting one or more authentication markers from the ink after scanning the ink with an IR vertical cavity surface emitting laser (VCSEL) reader integrated into a smartphone or compact device. The method may include verifying authenticity by comparing the one or more authentication markers to marker information stored on a blockchain-secured database.

According to other aspects of the present disclosure, the method may include one or more of the following features. The UV light and IR light may be generated using a UV LED and an IR VCSEL. The UV light may include a wavelength of 280 nm and/or 365 nm, and the IR light may include a wavelength of 800 nm and/or 940 nm. One or more authentication markers may include information received from phosphors. The ink may contain randomly dispersed aluminum flakes and fluorescent materials that may form a unique, traceable lightmap during writing. The method may include recording geo-location and time data during an authenticated signature event. The phosphor-based pen may be a pen having a pen body, a pen tip at a first end of the pen body, and one or more ink compartments with the pen body, each ink compartment operably coupled to the pen tip so as to dispense ink within the ink compartment substantially simultaneously, the ink containing phosphors that convert UV and IR light into distinct visible emissions.

According to another aspect of the present disclosure, an ink composition may be provided. The ink composition may include a solvent. The ink composition may include one or more UV phosphors. The ink composition may include one or more IR phosphors. The ink composition may include a black or blue pigment or dye. The ink composition may be free of carbon.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a cross-sectional view of a pen for authentication applications.

FIG. 2 illustrates a schematic diagram of a system utilizing the pen of FIG. 1.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

As used herein, the term “phosphor” refers to a luminescent material that absorbs electromagnetic radiation at one wavelength and emits electromagnetic radiation at a different wavelength. Phosphors exhibit the phenomenon of phosphorescence, wherein the emission of light continues for a period of time after the excitation source has been removed, in contrast to fluorescence where emission ceases substantially immediately upon removal of the excitation source. The duration of phosphorescent emission, characterized by decay time, may range from microseconds to hours depending on the specific phosphor composition and structure.

As used herein, the term “upconverting phosphor” refers to a phosphor material that absorbs lower-energy photons, such as infrared radiation, and emits higher-energy photons, such as visible light. Upconverting phosphors convert longer wavelength excitation light into shorter wavelength emission light through a multi-photon absorption process. Examples of upconverting phosphors include rare earth-doped materials such as ytterbium and erbium co-doped sodium yttrium fluoride (NaYF₄:Yb,Er), ytterbium and thulium co-doped sodium yttrium fluoride (NaYF₄:Yb,Tm), and ytterbium and holmium co-doped yttrium oxide (Y₂O₃:Yb,Ho).

As used herein, the term “downconverting phosphor” refers to a phosphor material that absorbs higher-energy photons, such as ultraviolet radiation, and emits lower-energy photons, such as visible light. Downconverting phosphors convert shorter wavelength excitation light into longer wavelength emission light through a single-photon absorption and emission process. Examples of downconverting phosphors include europium-doped yttrium oxide (Y₂O₃:Eu), terbium-doped gadolinium oxysulfide (Gd₂O₂S:Tb), and cerium-doped yttrium aluminum garnet (YAG:Ce).

As used herein, the term “substantially simultaneously” refers to the dispensing of ink from multiple compartments within a time period such that the inks are deposited together during a single writing stroke, allowing the inks to intermingle or be deposited in close proximity on a substrate. Substantially simultaneous dispensing does not require that the inks exit the pen tip at precisely the same instant, but rather that the inks are dispensed during overlapping time intervals such that a mark created by the pen contains contributions from each ink compartment.

As used herein, the term “forensic nanocrystal marker” refers to a nanoscale crystalline material incorporated into an ink composition that exhibits distinctive optical, magnetic, or chemical properties detectable through specialized analytical techniques. Forensic nanocrystal markers may include quantum dots, rare earth-doped nanoparticles, or other engineered nanostructures that provide a unique signature for authentication purposes.

As used herein, the term “IR transparent” refers to a material that permits transmission of infrared radiation without substantial absorption or attenuation. An IR transparent ink allows infrared excitation light to pass through the ink and reach phosphor particles dispersed therein, and further allows infrared-excited emissions from phosphors to propagate outward for detection.

As used herein, the term “rise time” refers to the time interval required for the luminescent emission intensity of a phosphor to increase from a baseline level to a specified fraction of its maximum intensity following the onset of excitation. As used herein, the term “decay time” refers to the time interval required for the luminescent emission intensity of a phosphor to decrease from its maximum intensity to a specified fraction thereof following the removal of excitation. Rise time and decay time are temporal characteristics that can vary among different phosphor compositions and can be used to encode information for authentication purposes.

As used herein, the term “lightmap” refers to a spatial pattern of optical responses generated by reflective, fluorescent, or other optically active elements dispersed within deposited ink. A lightmap may be formed by randomly dispersed aluminum flakes, fluorescent materials, or other visually distinguishing elements that create a unique and traceable pattern when the ink is applied to a substrate.

As used herein, the term “operably coupled” refers to a connection or relationship between components that enables the components to function together in an intended manner. Components that are operably coupled may be directly connected, indirectly connected through intervening elements, or functionally associated such that operation of one component affects or enables operation of another component.

As used herein, the term “blockchain-secured database” refers to a data storage system that utilizes blockchain technology to maintain records in a manner that is resistant to unauthorized modification. A blockchain-secured database may store authentication information, verification records, or other data in a distributed ledger where entries are cryptographically linked and validated across multiple nodes to ensure data integrity.

The present disclosure provides authentication and security solutions that address limitations of conventional anti-counterfeiting technologies. In contrast to traditional authentication methods such as holograms and QR codes that have proven susceptible to replication by counterfeiters, the disclosed pen and associated system employ phosphor-based inks that exhibit distinct luminescent responses under both ultraviolet and infrared excitation. The combination of multiple phosphor types within a single ink composition, along with the temporal characteristics of the luminescent emissions including rise time and decay signatures, provides a multi-layered authentication approach that is substantially more difficult to replicate than conventional security markers.

The disclosed pen is configured to dispense ink containing phosphors that convert UV and IR light into distinct visible emissions. The pen may include multiple ink compartments that are operably coupled to a pen tip so as to dispense ink from each compartment substantially simultaneously. This configuration enables the deposition of complex ink compositions containing multiple phosphor types, visually distinguishing elements such as reflective or holographic particles, and forensic nanocrystal markers. The resulting marks exhibit authentication characteristics that can be verified through both overt visual inspection and covert detection using specialized equipment.

The authentication system of the present disclosure integrates the phosphor-based pen with detection and verification components. An infrared vertical cavity surface emitting laser scanner may be integrated into a smartphone or compact reader to excite the phosphors within deposited ink and capture the resulting luminescent emissions. The spectral characteristics and temporal properties of the emissions can be analyzed to extract encoded data, which may then be compared against information stored in a blockchain-secured database. The system may further incorporate geo-tracking and date-stamping mechanisms to provide real-time authentication records that establish when and where a signature or mark was created.

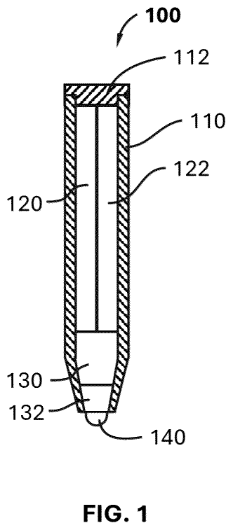

Referring to FIG. 1, a pen 100 is configured for authentication applications using phosphor-based inks. The pen 100 may provide both covert and overt authentication of official merchandise, documents, and branding materials through the use of specialized ink compositions that exhibit distinct luminescent responses under ultraviolet and infrared excitation.

The pen 100 includes a pen body 110 that serves as the main housing structure for internal components. The pen body 110 may be formed from plastic, metal, or other suitable materials that provide structural support and protection for the ink-containing components disposed within. A cap 112 is positioned at one end of the pen body 110 to protect a pen tip 140 when the pen 100 is not in use. The cap 112 may be removably attached to the pen body 110 through friction fit, threading, or other attachment mechanisms.

The pen body 110 contains one or more ink compartments in the form of ink reservoirs 120 and 122. Each ink reservoir 120, 122 may be configured to hold a different ink composition. The ink reservoirs 120 and 122 are operably coupled to the pen tip 140 through connectors 130 and 132, respectively. The connectors 130 and 132 facilitate the flow of ink from the respective ink reservoirs 120, 122 to the pen tip 140, allowing the inks to be dispensed substantially simultaneously during writing. The pen tip 140 is located at a first end of the pen body 110 opposite from the cap 112 and serves as the dispensing point for ink onto a substrate.

With continued reference to FIG. 1, the ink contained within the ink reservoirs 120, 122 contains phosphors that convert UV and IR light into distinct visible emissions. The one or more ink compartments may include a first ink compartment containing a first IR phosphor that emits a first color under IR excitation and a first UV phosphor that emits a second color under UV excitation. The ink reservoirs 120, 122 may contain micron-sized or sub-micron sized upconverting and/or downconverting phosphors. Upconverting phosphors absorb infrared light and emit visible light at shorter wavelengths, while downconverting phosphors absorb ultraviolet light and emit visible light at longer wavelengths.

The ink reservoirs 120, 122 may also contain IR absorbers as optical elements. The IR absorbers may be configured to absorb specific wavelengths of infrared light, providing an additional layer of authentication capability. The ink reservoirs 120, 122 may further contain retroreflective elements as optical elements that reflect incident light back toward its source, creating distinctive visual effects that can be detected during authentication.

At least one ink may include a visually distinguishing element. The visually distinguishing element may consist of a reflective element, a holographic element, and/or a fluorescent element. The visually distinguishing element may be selected so as to generate a unique identifying pattern in ink from the pen 100 that has been deposited onto a surface, where the unique identifying pattern can be detected by a sensor after being deposited.

The ink may be a colored pigment-based ink or a dye-based ink. For certain inks including black inks, carbon black pigments may be avoided due to their interference with and absorption of infrared light from excitation sources and phosphors. Accordingly, at least one ink may include black infrared transparent ink without carbon. Dye-based black inks with high IR transparency may be used instead to maintain the detectability of phosphor emissions under infrared excitation.

At least one ink may include at least one upconverting phosphor. The phosphors may be uniquely tuned to emit the exact chromaticity of each team's or brand's colors when illuminated with specific excitation wavelengths. The colors of emission may be chosen to match colors of a known brand, enabling authentication of branded merchandise through color-matched luminescent responses.

As further shown in FIG. 1, one or more phosphors may be included in a single reservoir or may be independently separated in a multi-chamber reservoir configuration whereby there are two distinct emissions. The heterogeneity of an autograph or mark created using the pen 100 can be detected by the human eye or using an imaging device. When writing with the pen 100, the inks may come out somewhat separately with some blending, showing two clearly different colors instead of one single blended color. One ink may have a slight viscosity difference versus another ink in the pen 100, causing the inks to come out of the pen tip 140 simultaneously but not at the same rate. This viscosity-based flow control enables the creation of marks with distinctive visual characteristics.

At least one ink may contain a phosphor whose spectral, rise time, and decay are capable of encoding an identifier specific to that phosphor. The identifier may be a player jersey number or a unique identifier. For example, if 10 UV phosphors and 10 IR phosphors with different emission profiles are used, any jersey number from 00 to 99 can be encoded using different combinations of UV and IR phosphors, where one phosphor type encodes the tens place and another phosphor type encodes the ones place. By combining multiple phosphors with multiple concentrations of phosphors in various inks, it is possible to create a nearly infinite number of unique identifiers for authentication purposes.

At least one ink may include a forensic nanocrystal marker as an additional security layer. The forensic nanocrystal markers may exhibit distinctive optical properties that can be detected using specialized equipment, providing an additional authentication mechanism beyond the phosphor-based emissions.

An ink composition for use in authentication applications may include a solvent, one or more UV phosphors, one or more IR phosphors, and a black or blue pigment or dye. The solvent may be an aqueous solvent such as water, or an organic solvent such as glycol, alcohol, or combinations thereof. The solvent serves as a carrier medium for the phosphors and pigments or dyes, enabling the ink composition to flow through the pen and be deposited onto a substrate during writing.

The one or more UV phosphors included in the ink composition may be downconverting phosphors that absorb ultraviolet radiation and emit visible light. As described above, examples of UV phosphors include europium-doped yttrium oxide, terbium-doped gadolinium oxysulfide, and cerium-doped yttrium aluminum garnet. The UV phosphors may be selected to emit specific colors under UV excitation, such as colors corresponding to team colors or brand colors for authentication purposes.

The one or more IR phosphors included in the ink composition may be upconverting phosphors that absorb infrared radiation and emit visible light. As described above, examples of IR phosphors include rare earth-doped materials such as ytterbium and erbium co-doped sodium yttrium fluoride, ytterbium and thulium co-doped sodium yttrium fluoride, and ytterbium and holmium co-doped yttrium oxide. The IR phosphors may be selected to emit specific colors under IR excitation that differ from the colors emitted by the UV phosphors, enabling multi-wavelength authentication.

The ink composition includes a black or blue pigment or dye that provides the visible color of the ink when viewed under ambient lighting conditions. The black or blue pigment or dye may be selected from organic dyes, inorganic pigments other than carbon-based pigments, or combinations thereof. Blue pigments or dyes may include phthalocyanine blue, indigo, or other blue colorants. Black pigments or dyes may include iron oxide black, spinel black, or dye-based black formulations.

The ink composition may be free of carbon-based pigments, or preferably may be free of carbon. Carbon-based pigments such as carbon black absorb infrared radiation, which interferes with the excitation of IR phosphors and attenuates the infrared emissions from the phosphors. By formulating the ink composition to be free of carbon, the ink maintains high IR transparency, allowing infrared excitation light to reach the IR phosphors dispersed within the ink and allowing the resulting infrared-excited emissions to propagate outward for detection. The carbon-free formulation enables the authentication characteristics of the IR phosphors to be detected without substantial signal loss due to absorption by the pigment.

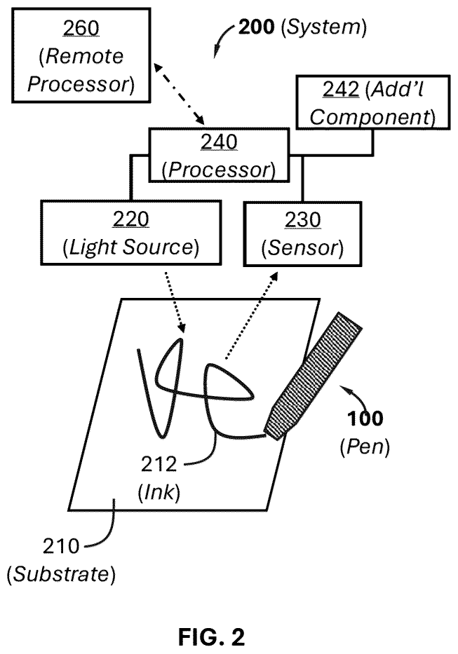

Referring to FIG. 2, a system 200 is configured to utilize the pen 100 for authentication and security applications. The system 200 integrates the phosphor-based pen 100 with detection, processing, and verification components to enable comprehensive authentication of documents, products, and signatures.

The pen 100 is configured to dispense ink 212 onto a substrate 210. The substrate 210 may be merchandise, a document, branding material, or other surface onto which a user applies a signature or mark using the pen 100. The ink 212 deposited on the substrate 210 contains phosphors that convert UV and IR light into distinct visible emissions, as described above with respect to the ink compositions contained within the ink reservoirs 120, 122.

A light source 220 is configured to emit UV and/or IR light toward the ink 212 disposed on the substrate 210. The light source 220 may include IR light sources such as vertical cavity surface emitting lasers (VCSELs). The light source 220 may also include UV light sources such as UV light emitting diodes (LEDs). When the light source 220 illuminates the ink 212, the phosphors contained within the ink 212 absorb the UV and/or IR light and emit other light in response. The UV light may include a wavelength of 280 nm and/or 365 nm, and the IR light may include a wavelength of 800 nm and/or 940 nm.

A sensor 230 is positioned to detect the emitted light from the ink 212. The sensor 230 may be configured to capture spectral information, intensity information, and temporal information related to the luminescent emissions from the phosphors. Detection of the phosphors may include device-enabled spectral and time response of both upconverting and downconverting phosphors. The sensor 230 may capture rise time and decay time characteristics of the phosphor emissions, enabling extraction of encoded identifiers from the ink 212.

Detection may also include visual identification of an upconverted and/or downconverted emission within the visible spectral range detectable by the human eye using a near-infrared (NIR) or UV light source. The visible emissions from the phosphors may be observed directly by a user when the ink 212 is illuminated by the light source 220, providing an overt authentication mechanism in addition to the covert detection performed by the sensor 230.

A processor 240 is operably coupled to the sensor 230 and optionally to the light source 220. The processor 240 may be configured to receive data from the sensor 230 and analyze the luminescence properties of the ink 212, including spectral characteristics and rise time and decay signatures, to determine encoded data. The processor 240 may process the detected emissions to extract authentication markers from the ink 212.

An additional component 242 is operably coupled to the processor 240. The additional component 242 may include a GPS receiver and/or a clock. The processor 240 may be operably coupled to the GPS receiver to receive location information relative to when the emitted light was detected. The processor 240 may also be operably coupled to the clock to receive time information relative to when the emitted light was detected. The GPS receiver and clock provide geo-tracking and date-stamping mechanisms to provide real-time authentication records that establish when and where a signature or mark was created.

With continued reference to FIG. 2, a remote processor 260 is operably communicating with the processor 240. The remote processor 260 may control verification information via a database. The remote processor 260 may also control verification information via a blockchain. The processor 240 may be configured to transmit information related to the ink 212 disposed on the substrate 210 to the remote processor 260. The remote processor 260 may be configured to receive the information and store the information in the database or blockchain. The remote processor 260 may also be configured to return a signal indicating whether the information matches what is already stored in the database or blockchain, thereby verifying authenticity.

The information of the ink 212 transmitted to the remote processor 260 may include a visual light image of the ink 212 while the ink 212 is emitting light. The visual light image may capture the color and spatial distribution of the luminescent emissions from the phosphors. The information of the ink 212 may also include a spectral image showing which wavelengths of light were detected by the sensor 230. The spectral image may provide detailed information about the emission profiles of the phosphors contained within the ink 212.

The system 200 may include an infrared (IR) vertical cavity surface emitting laser (VCSEL) scanner integrated into a smartphone or compact reader. The IR VCSEL scanner may be configured to emit at least one wavelength of light capable of being absorbed by the phosphors in at least one ink. The excitation may be provided by an illumination source integrated into a mobile phone, and the optical response of the optical elements within the ink 212 may be captured using the mobile phone camera. This integration enables portable authentication using consumer devices.

As described above, the system 200 may further include a clock and a GPS receiver operably coupled to the smartphone or compact reader to provide geo-tracking and date-stamping mechanisms to provide real-time authentication records. The combination of phosphor-based authentication, temporal and spectral analysis, location tracking, and blockchain-secured verification provides a multi-layered approach to authentication of documents, products, and signatures.

A method for authenticating a document, product, or signature may be performed using the phosphor-based pen and system described above. The method provides a multi-layered authentication approach that combines phosphor-based luminescent responses, temporal analysis, spatial pattern recognition, and blockchain-secured verification to establish the authenticity of marks, signatures, and branded items.

The method includes writing with a phosphor-based pen whose ink emits distinct visible emissions under UV and IR excitation. As described above, the phosphor-based pen may be a pen that includes a pen body, a pen tip at a first end of the pen body, and one or more ink compartments within the pen body, each ink compartment operably coupled to the pen tip so as to dispense ink within the ink compartment substantially simultaneously, the ink containing phosphors that convert UV and IR light into distinct visible emissions. A user may apply a signature, mark, or other writing to a document, product, or other substrate using the phosphor-based pen. The ink deposited during writing contains upconverting and downconverting phosphors that remain dormant under ambient lighting conditions but emit visible light when exposed to appropriate excitation wavelengths.

The method includes capturing the emitted color response after exposing the ink to ultraviolet (UV) light and infrared (IR) light. Following the application of ink to a substrate, the deposited ink may be illuminated with UV light and IR light from one or more light sources. The phosphors within the ink absorb the excitation light and emit visible light at wavelengths determined by the specific phosphor compositions present in the ink. The emitted color response may be captured using a camera, spectrometer, or other optical sensor capable of detecting the visible emissions from the phosphors.

The UV light and IR light may be generated using a UV LED and an IR VCSEL. The UV LED may emit ultraviolet radiation at wavelengths suitable for exciting downconverting phosphors within the ink. The IR VCSEL may emit infrared radiation at wavelengths suitable for exciting upconverting phosphors within the ink. The UV light may include a wavelength of 280 nm and/or 365 nm, and the IR light may include a wavelength of 800 nm and/or 940 nm. These wavelengths correspond to excitation bands of common phosphor materials used in authentication applications.

The method includes analyzing the luminescence properties, including spectral, rise time and decay signatures, to determine encoded data. The spectral characteristics of the emitted light may be analyzed to identify which phosphors are present in the ink based on their emission wavelengths. The rise time and decay signatures of the luminescent emissions may be measured and analyzed to extract encoded information. As described above, different phosphor compositions exhibit different rise times and decay times, and these temporal characteristics may be used to encode identifiers such as player jersey numbers or unique authentication codes. The combination of spectral and temporal analysis enables extraction of multi-dimensional encoded data from the deposited ink.

The method includes detecting one or more authentication markers from the ink after scanning the ink with an IR vertical cavity surface emitting laser (VCSEL) reader integrated into a smartphone or compact device. The IR VCSEL reader may emit infrared light toward the deposited ink and detect the resulting luminescent emissions from the upconverting phosphors. The smartphone or compact device may include a camera configured to capture images of the visible emissions, as well as processing circuitry configured to analyze the captured images and extract authentication markers. The one or more authentication markers may include information received from wave-shifting and absorbing phosphors present in the ink. Wave-shifting phosphors absorb light at one wavelength and emit light at a different wavelength, while absorbing phosphors selectively absorb specific wavelengths of light. The combination of wave-shifting and absorbing phosphors provides additional authentication information that can be detected and analyzed.

The ink may contain randomly dispersed aluminum flakes and fluorescent materials that form a unique, traceable lightmap during writing. The aluminum flakes may be reflective elements that create distinctive patterns when illuminated. The fluorescent materials may emit light at specific wavelengths when excited. The random dispersion of these elements during writing creates a spatial pattern that is unique to each mark or signature. The lightmap formed by the randomly dispersed aluminum flakes and fluorescent materials provides a physical unclonable function that can be captured and stored for subsequent verification.

The method includes verifying authenticity by comparing the one or more authentication markers to marker information stored on a blockchain-secured database. The authentication markers extracted from the deposited ink may be transmitted to a remote processor that maintains the blockchain-secured database. The remote processor may compare the received authentication markers against previously stored marker information to determine whether the markers match. A match indicates that the document, product, or signature is authentic, while a mismatch indicates potential counterfeiting or tampering. The blockchain-secured database provides tamper-resistant storage of authentication records, ensuring that stored marker information cannot be altered without detection.

The method may further include recording geo-location and time data during an authenticated signature event. A GPS receiver operably coupled to the smartphone or compact device may provide location information indicating where the signature event occurred. A clock operably coupled to the smartphone or compact device may provide time information indicating when the signature event occurred. The geo-location and time data may be recorded along with the authentication markers and stored in the blockchain-secured database. This geo-tracking and date-stamping mechanism provides real-time authentication records that establish the provenance of authenticated signatures and marks.

The method may be applied to sports authentication of official memorabilia, game-used items, and autographed merchandise. Athletes may use the phosphor-based pen to sign merchandise, and the authentication method may be used to verify that signatures are genuine. The encoded identifiers within the ink may correspond to player jersey numbers, enabling verification that a specific player created a specific signature.

The method may be applied to corporate branding to protect high-value brand identity items from counterfeiting. Brand owners may use the phosphor-based pen to mark official products, and the authentication method may be used to distinguish genuine products from counterfeit products. The phosphors within the ink may be tuned to emit colors matching official brand colors, providing both overt and covert authentication mechanisms.

The method may be applied to forensic security by adding traceable elements to legal and financial documents. The phosphor-based pen may be used to sign contracts, certificates, or other documents where authenticity verification is desirable. The authentication method may be used to verify that signatures on legal and financial documents are genuine and have not been forged or altered.

The disclosed pen, system, and method may be utilized in a variety of example applications relating to security and authentication uses.

In sports authentication applications, the phosphor-based pen and authentication system may be used to authenticate official memorabilia, game-used items, and autographed merchandise. Professional athletes, team officials, or authorized personnel may use the pen to sign jerseys, balls, photographs, trading cards, and other collectible items. The phosphor-based ink provides both visible and covert authentication markers that can be verified using the disclosed system. The ability to encode player jersey numbers or unique identifiers within the temporal characteristics of the phosphor emissions enables verification that a specific athlete created a specific signature. Authentication records stored in the blockchain-secured database provide a permanent and tamper-resistant record of when and where each signature was created.

In corporate branding applications, the phosphor-based pen and authentication system may be used to protect high-value brand identity items from counterfeiting. Brand owners may use the pen to mark official products, packaging, certificates of authenticity, or other branded materials. The phosphors within the ink may be tuned to emit colors matching official brand colors, providing visual confirmation of authenticity when illuminated with appropriate excitation wavelengths. The multi-layered authentication approach combining spectral analysis, temporal signatures, and blockchain verification enables brand owners to distinguish genuine products from counterfeit products with high confidence.

In forensic security applications, the phosphor-based pen and authentication system may be used to add traceable elements to legal and financial documents. The pen may be used to sign contracts, deeds, wills, certificates, checks, or other documents where verification of signature authenticity is important. The forensic nanocrystal markers and randomly dispersed elements within the ink create unique, traceable patterns that can be captured and stored for subsequent verification. The geo-location and time data recorded during signature events provide additional forensic evidence establishing the circumstances under which documents were signed.

A number of implementations have been described. Nevertheless, it will be understood that various modifications may be made without departing from the spirit and scope of the disclosure. Accordingly, other implementations are within the scope of the following claims.

1. A pen, comprising:
a pen body;
a pen tip at a first end of the pen body; and
one or more ink compartments with the pen body, each ink compartment operably coupled to the pen tip so as to dispense ink within the ink compartment substantially simultaneously, the ink containing phosphors that convert UV and IR light into distinct visible emissions.

2. The pen of claim 1, wherein the one or more ink compartments include a first ink compartment containing a first IR phosphor that emit a first color under IR excitation and a first UV phosphor that emits a second color under UV excitation.

3. The pen of claim 1, wherein at least one ink includes a visually distinguishing element, the visually distinguishing element consisting of a reflective element, a holographic element, and/or a fluorescent element.

4. The pen of claim 3, wherein the visually distinguishing element is selected so as to generate a unique identifying pattern in ink from the pen that has been deposited onto a surface, that can be detected by a sensor after being deposited.

5. The pen of claim 1, wherein at least one ink includes at least one upconverting phosphor.

6. The pen of claim 1, wherein at least one ink contains a phosphor whose spectral, rise time, and decay are capable of encoding an identifier specific to that phosphor.

7. The pen of claim 6, wherein the identifier is a player jersey number or a unique identifier.

8. The pen of claim 1, wherein at least one ink includes a forensic nanocrystal marker as an additional security layer.

9. The system of claim 8, further comprising a clock and a GPS receiver operably coupled to the smartphone or compact reader to provide geo-tracking and date-stamping mechanisms to provide real-time authentication records.

10. The pen of claim 1, wherein at least one ink includes black infrared (IR) transparent ink without carbon.

11. A system, comprising:
a pen of claim 1; and
an infrared (IR) vertical cavity surface emitting laser (VCSEL) scanner integrated into a smartphone or compact reader, the IR VCSEL scanner configured to emit at least one wavelength of light capable of being absorbed by the phosphors in at least one ink.

12. A method for authenticating a document, product, or signature, comprising:
writing with a phosphor-based pen whose ink that emits distinct visible emissions under UV and IR excitation;
capturing the emitted color response after exposing the ink to ultraviolet (UV) light and infrared (IR) light;
analyzing the luminescence properties, including spectral, rise time, and decay signatures, to determine encoded data;
detecting one or more authentication markers from the ink after scanning the ink with a IR vertical cavity surface emitting laser (VCSEL) reader integrated into a smartphone or compact device; and
verifying authenticity by comparing the one or more authentication markers to marker information stored on a blockchain-secured database.

13. The method of claim 12, wherein the UV light and IR light is generated using a UV LED and an IR VCSEL.

14. The method of claim 13, wherein the UV light includes a wavelength of 280 nm and/or 365 nm, and the IR light includes a wavelength of 800 nm and/or 940 nm.

15. The method of claim 12, wherein one or more authentication markers include information received from phosphors present in the ink.

16. The method of claim 12, wherein the ink contains randomly dispersed aluminum flakes and fluorescent materials that form a unique, traceable lightmap during writing.

17. The method of claim 12, further comprising recording geo-location and time data during an authenticated signature event.

18. The method of claim 12, wherein the phosphor-based pen is a pen of claim 1.

19. An ink composition, comprising:
a solvent,
one or more UV phosphors;
one or more IR phosphors;
a black or blue pigment or dye; and
wherein the ink composition is free of carbon.
